(19) United States
(12) Patent Application Publication
(10) Pub. No.: US 2005/0195376 A1
(43) Pub. Date: Sep. 8, 2005

(54) System for purifying purge gases

(76) Inventor: Dieter Schmerek, Hihling (DE)

Correspondence Address: Holland & Knight LLP;Suite 1300, One East Broward Boulevard, P.O. Box 14070, Ft. Lauderdale, FL, 33302-4070, US

(21) Appl. No.: 11/057,311

(22) Filed: Feb. 11, 2005

(30) Foreign Application Priority Data
Feb. 19, 2004 (DE) 10 2004 008 080.1

(51) Int. Cl. G03B 27/52

(52) U.S. Cl. 355/30; 355/53

(57) ABSTRACT

A system for purifying purge gases for an optical system, in particular for a projection objective for microlithography for the fabrication of semiconductor components, wherein the optical system has at least one optical element in a housing with a purge gas passing through the housing. Contaminating substances which settle on surfaces of the at least one optical element in the projection objective are filtered out by photochemical means.

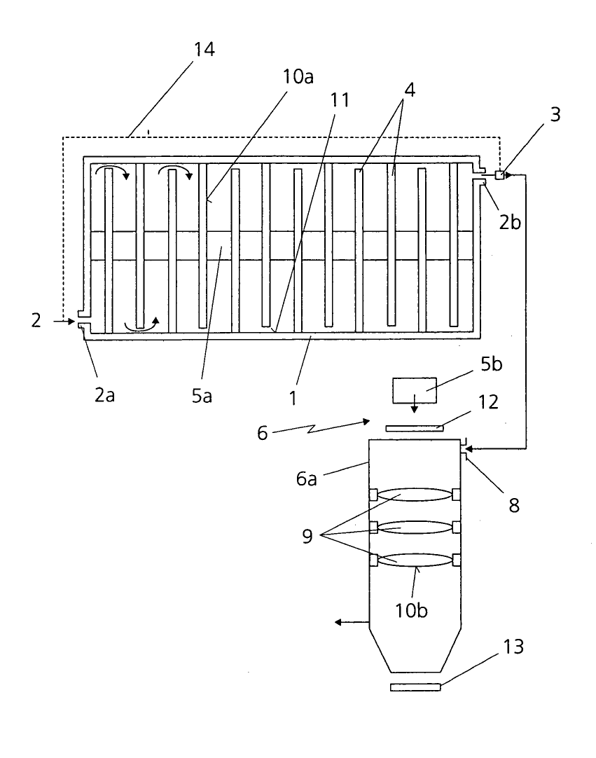

### BACKGROUND OF THE INVENTION

1. Field of the Invention

The invention relates to a system for purifying purge gases for an optical imaging apparatus having optical elements. In particular, the invention relates to a system for purifying purge gases for a projection objective for microlithography for the fabrication of semiconductor components and to a projection exposure installation.

2. Description of the Related Art

High-quality imaging apparatuses, in particular projection objectives used in EUV lithography, often have purge gas flowing through them.

Contaminating substances in the purge gas, such as for example SO₂ or phosphorus compounds, for projection objectives having a light source for EUV, DUV, VUV and 157 nm wavelength can lead to the formation of salts on optical elements, e.g. on coatings of lenses, such as for example antireflection coatings. This in turn has an adverse effect on the imaging properties, which can, for example, lead to the formation of scattered light and to a reduced contrast.

EP 1 223 468 A1 has disclosed a lithographic projection apparatus which has a pollutant/dirt barrier. The pollutant/dirt barrier in turn has an ionization device for ionizing a gas, the gas being provided in the region which the projection beam path passes through. The pollutant/dirt barrier is intended to eliminate undesirable pollutants and/or contaminating substances caused, for example, by a radiation source.

The ionization device may, for example, be an electron source or a plasma, which can be generated by a capacitive or inductive discharge or an alternating current discharge. According to a first proposal, it is possible to provide getter plates which are arranged upstream of the ionization device. The ionized gas and the contaminating substances are attracted by the getter plates, the latter being negatively charged. This allows the contaminating substances to be removed from the purge gas. Furthermore, the ionization effect can be improved by a magnetic trap which collects free electrons downstream of the purge gas.

Furthermore, it is possible to use plasma which is delimited by a tube. The tube is significantly longer than it is wide, so that electrons predominantly migrate toward the walls of the tube. A lack of electrons in the plasma volume generates a charge polarization caused by the ions. Therefore, the electrons migrate out of the plasma to the walls of the tube, where they are trapped. Antipolar diffusion of this nature also allows contaminating substances to be removed from the projection beam path. Apparatuses of this type are highly complex and expensive.

EP 1 102 124 A2 has disclosed an exposure apparatus which has an optical element, a gas supply unit and an organic substance decomposition mechanism. The gas supply unit is used to purge the optical element with gas. The organic substance decomposition mechanism in turn serves to decompose and eliminate organic substances in the gas on the basis of an electrical discharge process. The organic substance decomposition mechanism includes an electrical discharge unit which has discharge electrodes. The electrical discharge, such as a corona discharge or plasma discharge in the discharge unit, produces ionized atoms. A downstream filter unit eliminates substances which are formed through the decomposition of the organic substance.

EP 1 102 124 A2 describes a plurality of examples, it being possible for organic substances to be decomposed or broken down and eliminated by the use of organic substance decomposition mechanisms.

Hitherto, filters have primarily been used to eliminate the harmful substances. Since the disruptive substances present problems even at concentrations well below the detection limit, it is very difficult to qualify the filters for this purpose. Moreover, substances which may pass through the filter unimpeded if the filter is not specifically designed for this substance could also enter the purge gas. Quality problems can also lead to the filters themselves becoming the source of contamination.

### SUMMARY OF THE INVENTION

Therefore, it is an object of the invention to provide a system for purifying purge gases for an imaging apparatus, in particular for a projection objective, which eliminates contaminating substances that can lead to contamination, for example to salt formation, specifically as safely as possible and where possible without the use of filters.

According to the invention, the object is achieved by a system having a reactor having a reactor housing, which is provided with a purge gas inlet and with a purge gas outlet, contaminating substances that are present in the purge gas being deposited on deposition elements as they flow through the housing as a result of photochemical reactions using a light source, after which the purge gas which has been purified in this way is fed to the imaging apparatus.

According to the invention, a reactor which is responsible for purifying the purge gas before it enters the imaging apparatus, e.g. the projection objective, replaces a filter.

The photochemical process is advantageously carried out using a light source which at least approximately corresponds to the light source used in the optical imaging apparatus. In this way, the photochemical processes which would otherwise subsequently occur in the imaging apparatus, with contaminating substances being deposited on the optical elements, are anticipated.

In a highly advantageous configuration of the invention, it is possible to provide for the deposition elements used to include at least approximately the same material as at least some of the optical elements used in the imaging apparatus. If lenses are used as optical elements in a projection objective, which lenses are generally also provided with a coating on their surfaces, e.g. an antireflection coating, conditions which correspond to those employed in the subsequent imaging apparatus are in this way created in the reactor housing. In this way, preferably precisely those substances which would lead to contamination of the optical elements if there were no upstream reactor are deposited.

If, in the case of a projection objective, for example used in EUV lithography, quartz is used as material for lenses which are transparent with respect to the light source used, quartz plates or tubes made from quartz will advantageously be used for the deposition elements.

Further advantageous configurations and refinements of the invention will emerge from the further subclaims and the exemplary embodiment which is outlined below with reference to the drawing.

### BRIEF DESCRIPTION OF THE DRAWING

The only FIGURE diagrammatically depicts a system according to the invention for the purification of purge gases.

### DETAILED DESCRIPTION

The system according to the invention has a reactor housing 1 which may be in the shape of a bulb. Purge gas 2 flows into the interior of the reactor housing 1 at one end side via a purge gas inlet 2a and leaves the reactor housing via a purge gas outlet 2b at the other end side. A return control device 3, the function of which is described in more detail below, may be located in the region of the purge gas outlet 2b. A multiplicity of deposition elements 4 arranged in succession are located in the interior of the reactor housing 1. The deposition elements 4 are quartz plates which are arranged alternately on the peripheral wall of the reactor housing 1, in such a way as to produce a meandering flow of the purge gas 2 through the interior of the reactor housing 1 from the purge gas inlet 2a to the purge gas outlet 2b. The result of this measure is that the purge gas flows over the multiplicity of deposition elements 4 over a long flow path within a very small installation space and is therefore in contact with the surfaces of the deposition elements 4 for a prolonged period of time.

Inside the reactor housing 1 there is also a light source 5a, which advantageously extends at least approximately over the entire length of the reactor housing 1, with the result that the deposition elements 4 are intensively exposed to the light of the light source 5a.

To achieve optimum results, the wavelength of the light source 5a should correspond to a light source 5b which is provided in a projection exposure installation 6 with a projection objective 6a as the imaging apparatus. The projection objective 6a is connected to the purge gas outlet 2b via a feedline 7. Via a purge gas inlet 8 in the projection objective 6a, the purge gas 2, after it has flowed through the reactor housing 1, enters the interior of the projection objective 6a.

In terms of their material and/or surface coating, the deposition elements 4 should at least substantially correspond to the material of the optical elements 9, e.g. of lenses, which are used in the projection objective 6a. If the lenses 9 used in the projection objective 6a are provided with a coating 10b, the deposition elements 4 should be provided at their surfaces with a coating 10a which corresponds to the coating 10b of the optical elements 9. The coatings 10a and 10b may be provided on one or both sides of the optical elements 9 and deposition elements 4.

To make optimum use of the light source 5a, internal surfaces 11 of the reactor housing 1 may be provided with a mirror coating.

By way of example, the following light sources may be provided as light source 5a:
mercury (253.7 nm line)
mercury/xenon (approx. 190 nm line)
deuterium
laser, e.g. excimer laser, or
UV-LEDs.

When the purge gas 2 flows through the reactor housing 1, the process is substantially identical to the process which would cause the problems that have been explained above in the downstream projection objective 6a. Projection exposure installations having projection objectives 6a for microlithography for the fabrication of semiconductor components are generally known and consequently need not be described in more detail at this point. They have a mask or reticle 12, the pattern of which is imaged on a reduced scale onto a wafer 13. Purely by way of example, reference is made in this respect to EP 0 660 188 B1 or DE 102 18 989 A1. As the purge gas 2 passes through the reactor housing 1, the contaminating substances are subjected to a photochemical process by the light source 5a and are deposited in the form of salts on the deposition elements 4. In this way, the contaminating substances, such as for example SO₂ or phosphorus compounds, are as far as possible separated out and deposited before the purge gas 2 enters the projection objective 6a. This significantly reduces the formation of scattered light and greatly increases the imaging contrast.

If the deposition elements 4 are arranged exchangeably in the reactor housing 1, in a manner which is not illustrated in more detail, they can be exchanged after a certain defined operating time. In this case, the salts which have been deposited on the deposition elements 4 can be analyzed and conclusions can be drawn as to the quality of the purge gas 2 used.

The reactor housing 1 is arranged upstream of the projection objective 6a, as seen in the direction of flow of the purge gas, so that the interior of the projection objective is kept clear of contaminants.

If necessary, the purge gas 2 can be returned a number of times via a return purge line 14, as indicated by the dashed line, by means of the return control device 3, if the latter is arranged in the region of the purge gas outlet 2b or in the feedline 7 and is actuated accordingly.

In addition to the purified purge gas 2 being introduced into the interior of the projection objective 6a, it is if appropriate also possible for outer surfaces or spaces at the projection objective to be supplied with the purified purge gas 2 by means of a corresponding branch line which branches off from the feedline 7.

1. A system for purifying purge gases for an optical system, in particular for a projection objective for microlithography for the fabrication of semiconductor components, wherein the optical system has at least one optical element in a housing with a purge gas passing through the housing, wherein contaminating substances which settle on surfaces of the at least one optical element in the projection objective are filtered out by a photochemical process.

2. A system for a purifying purge gas for an optical imaging apparatus comprising optical elements, wherein the system includes a reactor comprising a reactor housing provided with a purge gas inlet and with a purge gas outlet, a light source and deposition elements, wherein contaminating substances that are present in the purge gas are to be deposited on said deposition elements as a result of photochemical reactions induced by light of said light source.

3. The system as claimed in claim 2, wherein said light source for the photochemical process at least approximately corresponds to the light source which is provided for said imaging apparatus.

4. The system as claimed in claim 2, wherein said deposition elements include at least approximately the same material as at least some of said optical elements used in said imaging apparatus.

5. The system as claimed in claim 4, wherein said deposition elements are provided with a coating which at least approximately corresponds to the coating of the surfaces of said optical elements.

6. The system as claimed in claim 2, wherein said deposition elements are in the form of plates or tubes.

7. The system as claimed in claim 2, wherein said deposition elements include a material which is transparent with respect to said light source used for the photochemical process.

8. The system as claimed in claim 7, wherein quartz is provided as material for said deposition elements.

9. The system as claimed in claim 1, wherein said light source for the photochemical process is arranged in the interior of said reactor housing.

10. The system as claimed in claim 8, wherein said light source extends at least approximately over the entire through-flow length of said reactor housing.

11. The system as claimed in claim 1, wherein a plurality of deposition elements are arranged in succession in said reactor housing and the purge gas flows over them in succession.

12. The system as claimed in claim 11, wherein said deposition elements are arranged in such a manner in said reactor housing that the purge gas flows through in meandering fashion.

13. The system as claimed in claim 2, wherein said reactor housing is provided with mirror-coated inner surfaces.

14. The system as claimed in claim 2, wherein said reactor housing is at least approximately in the shape of a bulb, with the purge gas inlet located at one end side of said bulb and the purge gas outlet located on the other side of said bulb.

15. The system as claimed in claim 2, wherein said deposition elements are arranged exchangeably in the reactor housing.

16. The system as claimed in claim 2, wherein the purge gas which emerges from the purge gas outlet can be fed via a return line to the purge gas inlet for the purpose of multiple purging.

17. The system as claimed in claim 16, wherein a return-flow control device is provided for the multiple purging.

18. The system as claimed in claim 2, wherein said imaging apparatus is a projection objective for microlithography for the fabrication of semiconductor components.

19. The system as claimed in claim 18, wherein a purge gas outlet of said reactor housing is connected via a feedline to a purge gas inlet at the projection objective.

20. A projection exposure installation comprising a projection objective for microlithography for the fabrication of semiconductor components, comprising optical elements and a purge gas system for purging the gas which enters the projection objective, wherein at least one light source and at least one deposition element is arranged in the purge gas system, said light source and the at least one deposition element being arranged upstream of said optical elements, as seen in the direction of flow of the purge gas, wherein contaminating substances are deposited on the at least one deposition element by a photochemical process induced by light from the light source.

21. A projection exposure installation comprising a projection objective for microlithography for the fabrication of semiconductor components, comprising optical elements and a purge gas system, wherein the purge gas system comprises a reactor with a reactor housing which is provided with a purge gas inlet and with a purge gas outlet, at least one light source and at least one deposition element, over which the purge gas flows, arranged in the reactor housing, and wherein said purge gas outlet of said reactor housing is connected to a purge gas inlet leading into said projection objective.

22. The projection exposure installation as claimed in claim 20 or 21, wherein said light source for a photochemical process at least approximately corresponds to the light source which is provided for the projection objective.

23. The projection exposure installation as claimed in claim 20 or 21, wherein the at least one deposition element includes at least approximately the same material as at least some of said optical elements arranged in said projection objective.

24. The projection exposure installation as claimed in claim 23, wherein the at least one deposition element is provided with a coating which at least approximately corresponds to the coating of the surfaces of said optical elements in said projection objective.

25. The projection exposure installation as claimed in claim 20 or 21, wherein at least one deposition element includes a material which is transparent with respect to said light source for the photochemical process.

26. The projection exposure installation as claimed in claim 21, wherein a plurality of deposition elements are arranged in succession, as seen in the direction of flow of the purge gas, in the reactor housing.

27. The projection exposure installation as claimed in claim 26, wherein said deposition elements are arranged in said reactor housing in meandering manner for the purge gas flowing through said reactor housing.

28. The projection exposure installation as claimed in claim 21, wherein the at least one deposition element is arranged exchangeably in said reactor housing.

29. The projection exposure installation as claimed in claim 21, wherein said purge gas outlet of said reactor housing is connected to said purge gas inlet of the reactor housing via a return line.

30. A process for purifying purge gases with a reactor, comprising a reactor housing provided with a purge gas inlet and with a purge gas outlet, a light source and deposition elements, wherein contaminating substances that are present in the purge gas are to be deposited on said deposition elements as a result of photochemical reactions induced by light of said light source.
